(19) United States
(12) Patent Application Publication
(10) Pub. No.: US 2026/0218673 A1
(43) Pub. Date: Jul. 30, 2026

(54) FUEL INJECTOR FOR DIRECT INJECTION OF GASEOUS FUEL

(71) Applicant: PHINIA DELPHI LUXEMBOURG SARL, Belvaux (LU)

(72) Inventor: Nicolas Rodier, Vineuil (FR)

(21) Appl. No.: 19/143,642

(22) PCT Filed: Dec. 22, 2023
(86) PCT No.: PCT/EP2023/087540

§ 371 Date: Jun. 26, 2025

(30) Foreign Application Priority Data
Dec. 29, 2022 (GB) 2219802.2

(51) Int. Cl. F02M 21/02

(52) U.S. Cl. CPC F02M 21/0254; F02M 21/0275

(57) ABSTRACT

A fuel injector for direct injection of gaseous fuel, extending along an axial direction from a proximal side to a distal side, includes: an injector body defining a fuel passage and having a distally disposed end portion that defines a valve seat extending around an outlet opening; an outward opening pintle received in the injector body to be axially movable between a proximal pintle position, in which it engages the valve seat to close the outlet opening, and a distal pintle position, in which it releases the outlet opening; an armature element for engaging the pintle from the proximal side and being axially movable between a proximal armature position and a distal armature position, which corresponds to the distal pintle position; and a solenoid actuator adapted to initiate a movement of the armature element towards the distal armature position. In order to provide reliable means for preventing impact damage in an injector for gaseous fuel, at least one damper space is defined between the armature element and the injector body so that a volume of the damper space is changed by an axial movement of the armature element, wherein a gap width of any gap in a boundary region delimiting the damper space is less than 15 μm, except for at least one gas-exchange path to which the damper space is connected, which gas-exchange path is open for gas exchange in any position of the armature element.

### TECHNICAL FIELD

The present invention relates to a fuel injector for direct injection of gaseous fuel.

### BACKGROUND OF INVENTION

For automotive applications, hydrogen engines are considered as a promising alternative to gasoline or diesel engines since the emissions from a hydrogen engine consist mainly of water. However, using hydrogen as a fuel in a combustion engine brings about several difficulties as compared to liquid fuels like gasoline or diesel. Specifically, while liquid fuel provides a considerable damping effect, in particular due to squeeze damping, such damping is negligible for a gaseous fuel. Accordingly, when a moving part of the injector engages another part during its movement in the injection cycle, the resulting impact is much more severe than in a comparable injector for liquid fuel. Also, the mass of the moving elements is oftentimes greater than in a liquid-fuel injector, which also increases the forces acting during impact. Over time, this may lead to deformation or even failure of a component. In particular, the injector valve may lose its sealing properties due to deformations of the injector pintle or the valve seat which the pintle engages during each injection cycle. The resulting injector leakage normally necessitates the replacement of the injector. Also, a severe impact may lead to a rebound of the pintle, thus increasing the time necessary to close the injector. Another similar problem occurs during the opening of the injector. According to a common design, an armature is attracted by a magnetized pole piece and finally engages the latter. Since the magnetic air gap between the armature and the pole piece is significantly reduced in the final phase of the movement, the acceleration and the speed of the armature increase considerably. On the one hand, the resulting impact may damage the armature or the pole piece. On the other hand, the pintle that is pushed by the pole piece may overshoot its opening position.

One option to alleviate this problem would be to reduce the closing speed of the armature and the pintle. In principle, this is possible by a brief electrical re-activation of the injector during closing. This so-called “soft-landing pulse” helps to slow down the pintle and thus reduce the impact load. However, it is difficult to sense the best timing for the pulse, wherefore satisfactory control of the pintle movement is hardly possible for the entire operating range of the injector. With regard to the opening of the injector, this concept is not applicable at all.

### TECHNICAL PROBLEM

It is thus an object of the present invention to provide reliable means for preventing impact damage in an injector for gaseous fuel.

This problem is solved by a fuel injector according to claim 1.

### GENERAL DESCRIPTION OF THE INVENTION

The invention provides a fuel injector for direct injection of gaseous fuel. In other words, the fuel injector is designed for an engine that is adapted for gaseous fuel. “Gaseous fuel” normally refers to a fuel that is gaseous under standard conditions, i.e., 15° C. and 101,325 Pa. Specifically, the gaseous fuel may be hydrogen (H₂). The fuel injector is adapted for direct injection of the gaseous fuel into a combustion chamber of a cylinder of the respective engine. However, this does not exclude the possibility that the fuel injector could be used for indirect injection.

The fuel injector extends along an axial direction from a proximal side to a distal side. The axial direction can correspond to an injector axis, which may be a symmetry axis of at least some parts of the fuel injector. When the fuel injector is installed to the engine, the proximal side is the side that faces away from the engine, while the distal side faces the engine. The general flow direction of the fuel is from the proximal side to the distal side.

The fuel injector comprises an injector body defining a fuel passage and having a distally disposed end portion that defines a valve seat extending around an outlet opening. The fuel passage extends through the injector body and communicates with the outlet opening, which is disposed on the distal side of the injector body. During operation, fuel is ejected from the fuel passage through the outlet opening. The end portion of the injector body at the distal side defines a valve seat that extends around the outlet opening. As a rule, the injector body comprises several components that are connected to each other. Several components or portions of the injector body may be made of metal, normally stainless steel. Normally, the valve seat and the outlet opening are symmetric with respect to the abovementioned symmetry axis of the fuel injector. Also, the fuel passage can be symmetric with respect to this axis. Usually, at least the end portion of the injector body is adapted to be inserted into a through-opening of a cylinder head, with the outlet opening being disposed near the inside of the cylinder head, i.e., near the combustion chamber.

The fuel injector further comprises an outward opening pintle received in the injector body to be axially movable between a proximal pintle position, in which it engages the valve seat to close the outlet opening, and a distal pintle position, in which it releases the outlet opening. The pintle is normally received in the injector body so that it can slide along the axial direction. The term “outward opening” refers to a pintle that moves outward with regard to the fuel passage as it opens, i.e., towards the cylinder. In the proximal pintle position, the pintle engages the abovementioned valve seat (in a gas-tight manner) to prevent fuel from exiting the fuel passage. In the distal pintle position, it disengages from the valve seat, thereby opening the fuel passage via the outlet opening. The proximal pintle position can therefore be referred to as a closed position and the distal pintle position can be referred to as an open position. As a rule, the pintle is also made of metal like stainless steel.

Further, the injector comprises an armature element for engaging the pintle from the proximal side and being axially movable between a proximal armature position and a distal armature position, which corresponds to the distal pintle position. The armature element may be made of a single piece or of several pieces, which are fixedly connected. It is adapted for engaging the pintle from the proximal side, i.e., it is at least partially disposed proximally of the pintle. This includes the possibility that it permanently engages the pintle or may even be fixedly connected thereto. The armature element is movable within the injector body. As it is moved from the proximal armature position to the distal armature position, it moves the pintle into the distal pintle position (i.e., the open position). As it moves from the distal armature position to the proximal armature position, the pintle can move back to the proximal pintle position (i.e., the closed position).

The injector also comprises an actuator, e.g. a solenoid actuator, adapted to initiate a movement of the armature towards the distal position, i.e., a distal movement. The solenoid is activatable to generate a magnetic field. This, in turn, moves the armature element from the proximal armature position towards the distal armature position. As a rule, the magnetic field magnetizes at least some components of the injector body, thereby creating magnetic attraction. Specifically, the armature element can be pulled towards the distal side. For instance, the injector body may comprise a magnetizable pole piece, which can be circumferentially disposed around the fuel passage. When the solenoid is activated, the pole piece is magnetized, thereby magnetically attracting the armature element.

A damper space is defined between the armature element and the injector body, so that a volume of the damper space changed by an axial movement of the armature element, wherein a gap width of any gap in a boundary region delimiting the damper space is less than 15 μm, preferably 10 μm or less, except for at least one gas-exchange path to which the damper space is connected, which gas-exchange path is open for gas exchange in any position of the armature element. As a rule, the term “gap width” refers to the smallest dimension of a gap. For instance, in case of a circular gap, this refers to the radial width, i.e., the difference between the outer radius and the inner radius of the gap. The damper space is defined or delimited by the armature element and the injector body. During the axial movement, its volume either decreases or increases. This increase or decrease in volume leads to a temporary underpressure or overpressure, since the gas inside the damper space is expanded or compressed. The damper space is mostly sealed by a close contact and/or a close clearance between the armature element and the injector body. Specifically, in the region delimiting the damper space, a gap width of any gap is less than 15 μm, except for at least one gas-exchange path to which the damper space is connected for gas exchange with another space. The respective region, which is referred to as the boundary region of the damper space, surrounds the damper space or is disposed around the damper space. It is formed by the armature element and the injector body. Likewise, any gap in this boundary region is defined by at least one of the armature element and the injector body. This includes the possibility of a gap being formed between parts of the armature element or between parts of the injector body. Since the armature element is movable relative to the injector body, it is not possible, or at least hardly possible, to reduce the gap width of every gap to zero. However, the described gap width is so small that no significant gas exchange can occur during the movement of the armature element, which effectively provides a sealing effect. As a rule, the damper space is filled with the same gaseous fuel as the fuel passage. This can be due to minor gas exchange through the gap(s) between the armature element and the injector body. As stated above, this gas exchange is negligible during the movement of the armature element and the pintle, which usually takes place in less than 1 ms. The specified upper limit for the gap width applies to any gap except for the at least one gas-exchange path. In principle, this includes the possibility that the gas-exchange path represents the only gap in the boundary region, in which case the limit applies to no gap.

The damper space is not completely sealed, but it is open for gas exchange via at least one gas-exchange path. Accordingly, it is possible to expel gas from the damper space in case of overpressure and to suck gas into the damper space in case of underpressure. The abovementioned limit for the gap width does not apply to the gas-exchange path. I.e., the gas-exchange path, or a part thereof adjacent the damper space, preferably has a gap width of more than 10 μm or of at least 15 μm. However, since all other parts of the abovementioned boundary region around the damper space can be regarded as sealed, the at least one gas-exchange path effectively controls the speed or amount of gas exchange. The gas-exchange path can be designed small enough that the gas exchange occurs comparatively slowly, thus allowing a significant overpressure or underpressure to build up. This leads to a force that counteracts the movement of the armature. Accordingly, a pneumatic damping or braking effect commences, which reduces the speed of the armature element compared to a design without the damper space. One could also say that the acceleration of the armature element is reduced, possibly even leading to a deceleration. As a consequence, the speed of the pintle is also reduced, which leads to a less severe impact between the pintle and the valve seat. On the other hand, when the armature element moves to the distal armature position and the pintle moves to the distal pintle position, the volume of the damper space changes in an opposite way, an opposite pressure difference can be created, which also leads to a pneumatic damping effect. Accordingly, the intensity of an impact between the armature element and the injector body is reduced. The fuel injector is adapted so that the at least one connecting channel is open for gas exchange in any position of the armature element, especially in the proximal armature position and in the distal armature position. Thus, gas exchange via the gas-exchange path is always possible. Preferably, the at least one gas-exchange path is at least partially defined by at least one of the armature element and the injector body. Specifically, it may be defined within the armature element or between the armature element and the injector body.

The inventive injector employs pneumatic damping. The working fluid for the damper can be the gaseous fuel that is available in the injector during operation at all times, i.e., no additional working fluid is necessary. The braking or dampening effect occurs as a result of the movement of the armature and does not require any sensor or actuator for its control. Accordingly, a properly timed damping effect can be achieved with comparatively simple, mechanical means. Since the gas-exchange path is open in any position of the armature element (i.e., during the entire movement of the armature element), the damper space is never completely isolated and excessive overpressure or underpressure is avoided.

The function of the damper space is to generate a temporary pressure difference that results in a braking force on the armature element. However, it is neither necessary nor desirable to maintain an underpressure in the damper space for a longer time. After the armature element has reached the proximal armature position or the distal armature position, a partial or full pressure equalization can be performed between the fuel passage and the damper space. To this respect, a small but still non-zero gap width between the armature element and the injector body can be useful. These small gaps may allow for at least some gas exchange. This may refer to a gap representing a gas-exchange path and/or to another gap, which has the abovementioned limited gap width.

Preferably, the armature element comprises an armature shaft, with a hollow sleeve portion disposed around a shaft channel that at least communicates with the fuel passage, and an armature that is circumferentially disposed around the armature shaft and fixedly connected thereto and that is disposed in a cylinder portion of the injector body, wherein at least one damper space is disposed axially between the armature and a guide portion of the injector body that protrudes radially inwards from the cylinder portion towards the armature shaft and that partially receives of the armature shaft. The armature shaft can be elongate in the axial direction. Likewise, the overall shape of the sleeve portion can be cylindrical. The sleeve portion is disposed around the shaft channel, which is either in fluid communication with the fuel passage or can be regarded as a part of the fuel passage. The sleeve portion is at least partially hollow with the shaft channel disposed therein. The guide portion partially receives the armature shaft. It guides the axial movement of the armature shaft and accordingly the movement of the armature element as a whole. Accordingly, the dimensions of the armature shaft and the guide portion correspond to each other. Both normally have a constant cross-section along the axial direction, which facilitates the guided axial movement. While the guide portion receives a part of the armature shaft, other parts are disposed outside of the guide portion. The overall shape of the guide portion is normally annular. For assembly reasons, the guide portion can be a separately manufactured element that is arranged inside the injector body. The guide portion may be positioned inside the body in a floating/sliding manner or may be connected to the rest of the injector body, e.g., by press-fitting or welding. While it may at least partially be made of metal, e.g., stainless steel, it may comprise a guide bearing that is disposed next to the armature shaft and that is made of a different material, e.g., a ceramic, a polymer or the like.

The armature is normally fixed to an outside of the sleeve portion. The general shape of the armature may be annular. It is also received in the injector body, namely in a cylinder portion, and is axially movable. Accordingly, the dimensions of the armature and the cylinder portion correspond to each other. Both normally have a constant cross-section along the axial direction, which facilitates the guided axial movement. Since each guide portion protrudes radially inwards from the cylinder portion, the armature cannot enter the respective guide portion. Usually, the positions and geometry of the armature and the guide portions define the proximal and distal armature position, respectively. I.e., when the armature engages a guide portion, the armature cannot be moved any further, and since it is fixedly connected to the armature shaft (e.g., by welding), the armature shaft cannot move any further either. At least one damper space is disposed axially between the armature and a guide portion. One could also say that the armature and the guide portion represent the proximal and distal limit of the damper space.

One embodiment provides that the armature and the guide portion are formed so that they define a damper space with a non-zero volume between them when they engage each other. If the armature is considered as a plunger or piston that moves within the cylinder portion, one could say that in this embodiment, there is a dead space, i.e., a portion of the damper space that cannot be fully compressed by the armature. This can be beneficial since reducing the volume to zero could lead to an extreme counterforce on the armature. If there always remains a rest volume, the maximum possible compression is limited. Either the armature or the guide portion can comprise an axially extending recess that is not accessible by the other element.

According to one embodiment, a proximal damper space is disposed proximally of the armature and axially between a proximal guide portion of the injector body and the armature. The gas in this proximal damper space is compressed when the armature element moves to the proximal armature position and is expanded when the armature element moves to the distal armature position.

Alternatively or additionally, a distal damper space can be disposed distally of the armature and axially between the armature and a distal guide portion of the injector body. The gas in this distal damper space is compressed when the armature element moves to the distal armature position and is expanded when the armature element moves to the proximal armature position. The distal guide portion may comprise the abovementioned pole piece. By activating the solenoid, the pole piece is magnetized, and the armature is pulled towards the distal guide portion. It is explicitly preferred that the fuel injector comprises the distal damper space and the proximal damper space.

The fuel injector preferably comprises the proximal damper space and the distal damper space, which are connected by at least one gas-exchange path. In this embodiment one damper space serves as the exchange space for the other damper space. During the movement of the armature element, gas is moved from one damper space to the other damper space. However, as explained, due to the dimensions of the gas-exchange path, the gas exchange is so slow that an underpressure builds in one damper space while an overpressure builds in the other damper space. No complete pressure equalization is possible during the movement of the armature element. In this embodiment, the only connection between each damper space and the fuel channel is through the small gaps between the armature element and the injector body. However, this is no problem since the combined volume of both damper spaces always remains the same, wherefore there is no need to transfer gas to or from the fuel passage.

Another embodiment provides that a gas-exchange path extends radially and traverses a sleeve wall of the sleeve portion to connect a damper space with the shaft channel. Accordingly, the shaft channel is the exchange space for the respective damper space. Gas can be exchanged through the sleeve wall between the shaft channel and the damper space. The gas-exchange path extends along the radial direction and may optionally be parallel thereto. In case of two damper spaces, there can be one such gas-exchange path for each damper space. With respect to the tangential direction, the gas-exchange path is normally limited to an angle of less than 10° or less than 5°.

According to one embodiment, a gas-exchange path extends axially and traverses the armature. In this embodiment, the gas-exchange path connects the proximal damper space with the distal damper space, which are otherwise separated by the armature. The gas-exchange path extends along the axial direction and may optionally be parallel thereto. With respect to the tangential direction, the gas-exchange path is normally limited to an angle of less than 10° or less than 5°.

It is also possible that a gas-exchange path extends axially and is formed in a radially outer surface of the armature. In this case, the gas-exchange path is a groove in the outer surface. While the armature and the cylinder portion are otherwise in close contact with each other, they are separated by a somewhat greater distance in the position of the gas-exchange path. Like in the abovementioned embodiment, the gas-exchange path connects the proximal damper space with the distal damper space. The gas-exchange path extends along the axial direction and may optionally be parallel thereto. With respect to the tangential direction, the gas-exchange path is normally limited to an angle of less than 10° or less than 5°.

One embodiment provides that an at least mostly annular gap between the armature and the cylinder portion has a width of less than 15 μm, preferably 10 μm or less. “At least mostly annular” means that the gap may be either fully annular, extending 360° around the armature, or mostly annular, extending less than 360° but normally more than 300° around the armature. One option would be that the gap extends over 355° and an abovementioned groove in the outer surface extends over the remaining 5°. In the region with the groove, i.e., the region of the gas-exchange path, the width of the gap can be considerably greater, e.g., over 500 μm.

The gas-exchange path may generally have a cross-sectional area between 0.05 mm² and 0.7 or 0.8mm², in particular between 0.1 and 0.6mm². In embodiments, the gas-exchange path may have a cross-section with a transverse dimension between 0.1 mm and 1 mm. In case of a radial gas-exchange path, the cross-section refers to the axial-tangential plane, in case of an axial gas-exchange path, it refers to the radial-tangential plane. The transverse dimension may be the same in every direction, i.e., the cross-section may be circular. In this case, the diameter may be between 0.3 mm and 0.8 mm. Other shapes are possible, too. For example, the cross-section could be oval, rectangular, or square-shaped. In any case, the area of the cross section should not be too small in order to prevent excessive buildup of overpressure or underpressure, but not too great in order to prevent premature gas exchange. Appropriate dimensions can be readily determined by those skilled in the art.

With the abovementioned radial or axial gas-exchange paths, there is normally only a minimal gap between the armature and the cylinder portion, which can be largely considered as sealed within the timeframe of the armature movement. According to a different embodiment, a gas-exchange path is formed by an annular gap disposed radially between the armature and the cylinder portion, which annular gap may have a width between 15 μm and 25 μm, referring to the radial direction. In this case, a somewhat larger gap is purposefully used to serve as a gas-exchange path. In comparison to other embodiments, this one allows for a simpler manufacturing since there is no need to provide a dedicated path e.g., by drilling. On the other hand, eccentric placement of the armature can considerably affect the gas flow through the annular gap, thus making the damping behavior more difficult to predict.

One option to provide a sealing contact between the armature and the cylinder portion is to closely match their respective dimensions. This is possible but make the manufacturing more difficult and costly. Alternatively, at least one seal element can be radially interposed between the armature and the cylinder portion, wherein a seal-element gap between the seal element and the injector body has a maximum width of less than 15 μm. The seal element may comprise several parts or a plurality of seal elements may be employed. The seal element may be received in an annular groove in the outer surface of the armature. At least one seal element may be made of elastic and/or friction-reducing material like, e.g., PTFE. As a rule, the at least one seal element is disposed circumferentially about the injector axis.

According to one option, the armature element and the pintle could be fixedly connected or could even be made of a single piece. Alternatively, the armature element and the pintle can be separate elements. In the latter case, the armature element is adapted to engage the pintle and move it distally as the armature element itself moves towards the distal armature position, and the pintle is adapted to engage the armature element and move it proximally as the pintle itself moves towards the proximal pintle position. During the injection cycle, the pintle and the armature element may be in permanent contact, or they may temporarily disengage.

Reliable contact between the pintle and the armature element can be provided if a distal force acts on the armature element. According to an embodiment, an armature spring biases the armature element towards the distal armature position. By the action of the armature spring, the armature element is pressed against the pintle. Normally, the armature spring is interposed between the injector body and the armature element. Preferably, the armature spring is a coil spring made of spring steel, but other materials or designs are possible, too. As a rule, the pintle is biased towards the proximal pintle position by a pintle spring. The pintle spring may be a coil spring circumferentially disposed around the pintle. It is normally a pressure spring that is interposed between the pintle and the injector body. It should be understood that the closing of the injector is caused by the action of the pintle spring. Also, during at least a part of the proximal movement, the pintle spring may act, through the pintle and the armature element, against the above-mentioned armature spring. Accordingly, the force of the pintle spring has to be considerably greater than that of the armature spring in order to guarantee a reliable closing of the fuel injector. Although reference is made to “an armature spring” and “a pintle spring”, it will be understood that a plurality of armature springs and/or pintle springs could be employed.

In another embodiment, the armature spring may be positioned distally with respect to the pintle, hence pushing the armature element in proximal direction, whereby a gap exists between the armature element and pintle.

### BRIEF DESCRIPTION OF THE DRAWINGS

Preferred embodiments of the invention will now be described, by way of example, with reference to the accompanying drawings, in which:

FIG. 1 is a sectional view of a first inventive fuel injector with an armature element in a proximal armature position;

FIG. 2 is a sectional view of the fuel injector from FIG. 1 with the armature element in a distal armature position;

FIG. 3 is a detail view of FIG. 1;

FIG. 4 is a detail view of a second inventive fuel injector;

FIG. 5 is a detail view of a third inventive fuel injector;

FIG. 6 is a detail view of a fourth inventive fuel injector;

FIG. 7 is a detail view of a fifth inventive fuel injector;

FIG. 8 is a detail view of a sixth inventive fuel injector; and

FIG. 9 is a detail view of a seventh inventive fuel injector.

### DETAILED DESCRIPTION OF THE EMBODIMENTS

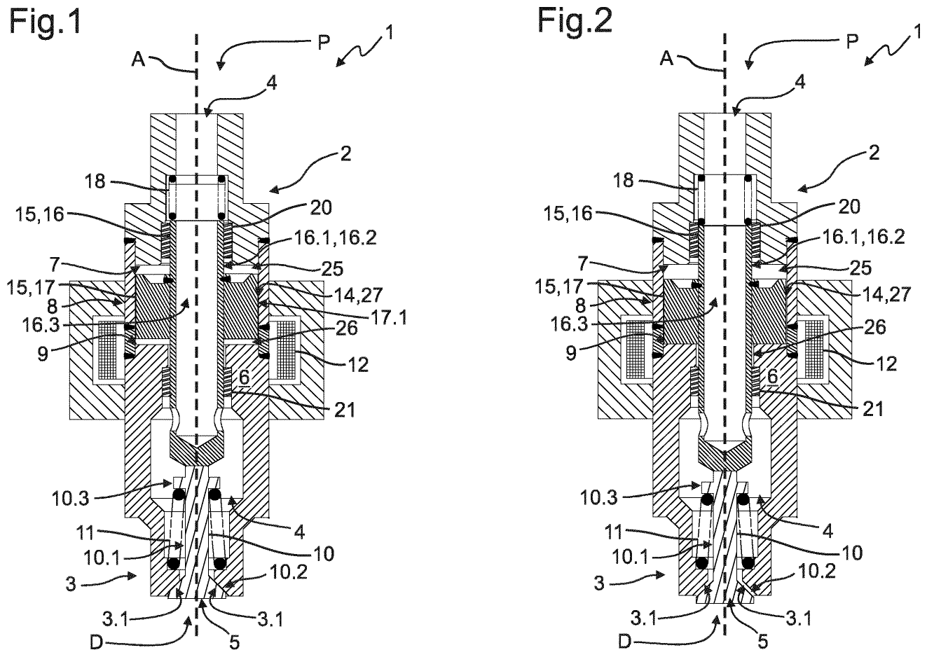

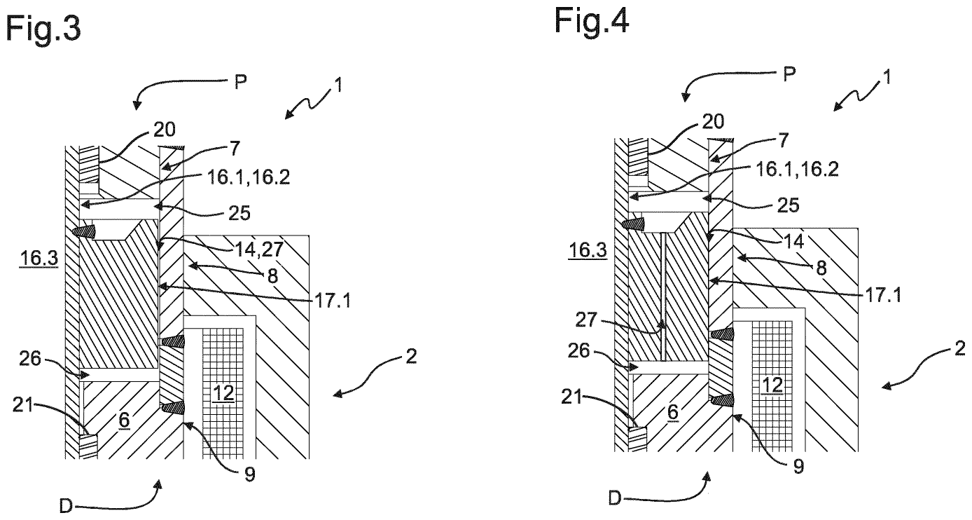

FIGS. 1-3 show a fuel injector 1 according to the present invention. The fuel injector 1 is adapted to inject a gaseous fuel, in particular H₂, into a cylinder head of a combustion engine (not shown). The fuel injector 1 is mostly symmetrical to an axial direction A. It comprises an injector body 2 that is at least partially made of stainless steel. When installed to the engine, at least an end portion 3 of the injector body 2 is inserted into a through-opening of the cylinder head. The injector body 2 defines a fuel passage 4, which extends axially from a proximal side P towards a distal side D, where it communicates with an outlet opening 5. A pintle 10 is movably received inside the injector body 2. In a closed position, which is shown in FIG. 1, a pintle head 10.2, which radially protrudes from a pintle shaft 10.1, closes the outlet opening 5. Specifically, the pintle head 10.2 rests against a valve seat 3.1 that is formed by the end portion 3 around the outlet opening 5. The pintle 10 is also made of stainless steel. It is biased by a pintle spring 11 towards a proximal pintle position shown in FIGS. 1 and 3. The pintle spring 11 engages a pintle perch 10.3 that protrudes from the pintle shaft 10.1.

Proximally of the pintle 10, an armature element 15 is disposed inside the injector body 2. The armature element 15 is biased by an armature spring 18 towards the distal side D. It comprises an elongate, roughly cylindrical armature shaft 16 and an annular armature 17 that circumferentially surrounds the armature shaft 16 and is connected thereto by welding. The armature 17 is axially movable within a cylinder portion 8 of the injector body 2. To the proximal side P, the armature 17 faces a proximal guide portion 7, in which a part of the armature shaft 16 is received. To the distal side D, the armature 17 faces a distal guide portion 9, which also receives a part of the armature shaft 16. The guide portions 7, 9 comprise a proximal guide bearing 20 and a distal guide bearing 21, respectively, which circumferentially enclose the armature shaft 16 and can be made of a ceramic or a polymer.

The distal guide portion 9 comprises a pole piece 6 which is disposed circumferentially around the armature shaft 16. The pole piece 6 is magnetizable by a solenoid 12, which generates a magnetic field when it is activated. By the magnetization of the pole piece 6, the armature 17 and the entire armature element 15 can be pulled towards the distal side D in a distal movement. FIG. 1 shows the armature element 15 in a proximal armature position, in which the armature 17 and the pole piece 6 are axially spaced apart.

The armature shaft 16 comprises an elongate, hollow sleeve portion 16.1 with a sleeve wall 16.2 that circumferentially surrounds a shaft channel 16.3. During operation, gaseous fuel flows through the shaft channel 16.3, which can be regarded as a part of the fuel passage 4. The armature shaft 16 is guided by the annular guide bearings 20, 21. A gap width between each guide bearing 20, 21 and the armature shaft 16 is below 15 μm, preferably 10 μm or below. Preferably, the gap is as small as possible, possibly in practice about 5 or 10 μm. On the other hand, an annular gap 14 between an outer surface 17.1 of the armature and the cylinder portion 8 has a somewhat greater width of e.g., 15 to 20 μm.

Unless otherwise indicated, the gap dimensions indicated herein are ‘radial’. Since the parts are mostly symmetrical, the gap extends normally all around, and thus is measured twice along a diameter. In other words, the gap width at the armature shaft and guide bearings is 15 μm, preferably 10 μm or below with respect to the radius (hence ‘radial’); which corresponds to a gap of 30 μm, preferably 20 μm or less along the diameter.

A proximal damper space 25 is formed on the proximal side P of the armature 17, while a distal damper space 26 is formed on the distal side D of the armature 17. Due to the non-zero gap width between the armature shaft 16 and the guide bearings 20, 21, minimal gas exchange between the damper spaces 25, 26 and the fuel passage 4 is possible. Thus, both damper spaces 25, 26 are filled with gaseous fuel. In FIG. 1, the proximal damper space 25 has its minimum volume and the distal damper space 26 has its maximum volume. When the solenoid 12 is activated and magnetizes the pole piece 6, the armature element 15 is pulled towards the distal armature position, which is shown in FIG. 2. Since the armature shaft 16 engages the pintle 10, the pintle 10 is also pushed towards the distal pintle position and the injector 1 starts to open. As the armature 15 moves towards the distal armature position, the volume of the proximal damper space 25 increases while the volume of the distal damper space 26 decreases. Correspondingly, the gaseous fuel in the proximal damper space 25 expands while the gaseous fuel in the distal damper space 26 is compressed. This, in turn, leads to a pressure difference which creates a force that counteracts the distal movement of the armature element 15. This force reduces the acceleration of the armature element 15 or even reduces its speed. The same applies to the pintle 10 that is driven by the armature shaft 16. Therefore, when the armature 17 engages the distal guide portion 9, there is no excessive impact force that could lead to damage. Also, the pintle 10 is unlikely to overshoot as the armature element 15 is stopped by the distal guide portion 9.

As explained above, minimal gas exchange between the damper spaces 25, 26 and the fuel passage 4 is possible. In fact, during the movement of the armature element 15 from the proximal armature position to the distal armature position, this gas exchange can be neglected. However, a non-negligible gas exchange occurs via the annular gap 14, which constitutes a gas-exchange path 27 between the damper spaces 25, 26. Gas flow through the gas-exchange path 27 limits the buildup of the pressure difference between the damper spaces 25, 26. This, in turn, has an effect on the force resulting from the pressure difference. By adapting the width of the annular gap 14, it is therefore possible to adapt the damper effect. Specifically, the annular gap 14 may have a gap width between 15 μm and 25 μm. Therefore, each gap in a boundary region delimiting the respective damper space 25, 26 has a gap width of less than 15 μm, apart from the gas-exchange path 27, which has a larger gap width. After the armature element 15 has reached the distal armature position, a pressure equalization between the damper spaces 25, 26 can be completed via the gas-exchange path 27. Apart from the gas exchange through the gas-exchange path 27, which is open in any position of the armature element 15, excessive overpressure is also prevented by the fact that neither the volume of the proximal damper space 25 in the proximal armature position nor the volume of the distal damper space 26 in the distal armature position is reduced to zero.

When the solenoid 12 is deactivated, the armature 17 is no longer attracted towards the pole piece 6. Accordingly, the force of the pintle spring 11 pushes the pintle 10 towards the proximal pintle position and, accordingly, the armature element 15 is pushed towards the proximal armature position in a proximal movement. During this time, the armature element 15 is kept in contact with the pintle 10 by the force of the armature spring 18. As the armature element 15 moves towards the proximal armature position, the volume of the proximal damper space 25 decreases, while the volume of the distal damper space 26 increases. Accordingly, an overpressure in the proximal damper space 25 and an underpressure in the distal damper space 26 are created. The resulting pressure difference again leads to a force that counteracts the movement of the armature element 15. This force reduces the acceleration of the armature element 15 or even reduces its speed. The same applies to the pintle 10. Therefore, when the pintle head 10.2 engages the valve seat 3.1, there is no excessive impact force that could damage the pintle head 10.2 or the valve seat 3.1 and lead to injector leakage.

FIGS. 4 to 9 show various embodiment of inventive fuel injectors, which are largely the same as the one shown in FIGS. 1 to 3 and thus will not be explained again. While the annular gap 14 between the armature 17 and the cylinder portion 8 is somewhat wider in the first embodiment, the width of this annular gap 14 is reduced to less than 15 μm in the remaining embodiments. FIG. 4 shows a second embodiment, in which a gas-exchange path 27 axially traverses the armature 17, thereby connecting the damper spaces 25, 26. This embodiment normally allows better control of the gas flow, since the gas flow in the first embodiment is highly sensitive to a possible eccentric position of the armature 17 within the cylinder portion 8. The gas-exchange path 27 has a circular cross-section with a diameter of 0.4 mm.

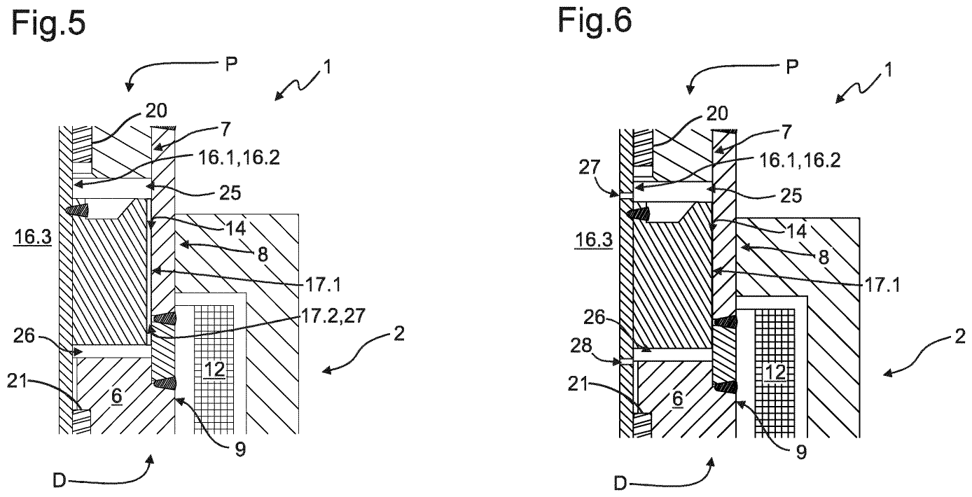

FIG. 5 shows a third embodiment, in which a gas-exchange path 27 extends axially and is formed by an axial groove or recess 17.2 in the outer surface 17.1 of the armature 17. In this example, the gas-exchange path has a square-shaped cross-section with an edge length of 0.3 mm. It will be understood that apart from this recess 17.2, the width of the annular gap 14 is below 15 μm, as stated above.

FIG. 6 shows a fourth embodiment, in which the damper spaces 25, 26 are not directly connected to each other. Rather, a first gas-exchange path 27 radially traverses the sleeve wall 16.2, thereby connecting the proximal damper space 25 with the shaft channel 16.3. Correspondingly, a second gas-exchange path 28 radially traverses the sleeve wall 16.2 and connects the distal damper space 26 with the shaft channel 16.3. Accordingly, as the armature element 15 moves between the proximal armature position and the distal armature position, each damper space 25, 26 can receive gaseous fuel from the shaft channel 16.3 or expel gaseous fuel into the shaft channel 16.3, respectively.

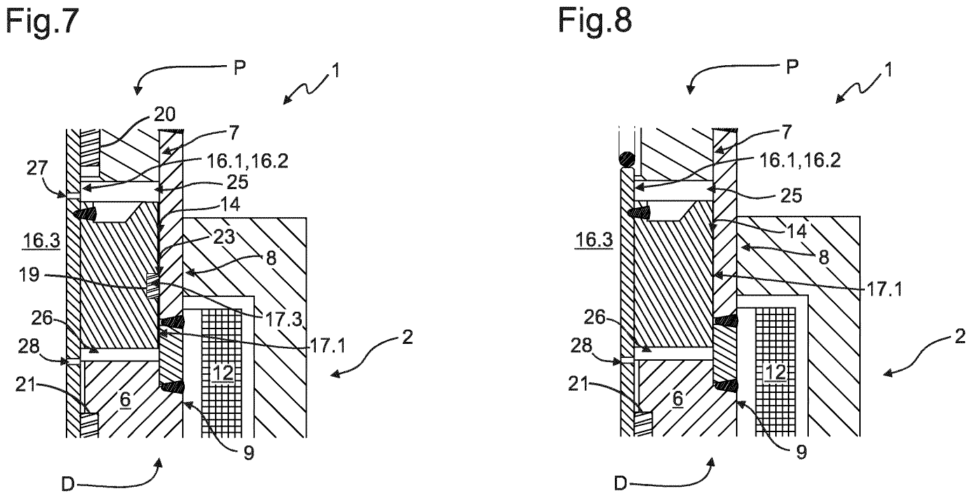

FIG. 7 shows a fifth embodiment, which differs from the sixth embodiment in that a seal element 19 is disposed in an annular recess 17.3 of the outer surface 17.1 of the armature 17. While the width of the annular gap 14 may be considerably larger than 15 μm, a seal-element gap 23 between the seal element 19 and the cylinder portion 8 has a width that is considerably below 15 μm.

FIG. 8 shows a sixth embodiment, in which the proximal guide bearing 20 has been omitted and the proximal guide portion 7 has no actual guiding function. The armature shaft 16 is spaced apart from the proximal guide portion 7 to allow for basically free gas exchange. Accordingly, there is no proximal damper space 25 in this embodiment. The damping behavior is exclusively controlled by the distal damper space 26, which is again connected to the shaft channel 16.3 via a gas-exchange path 28 that radially traverses the sleeve wall 16.2.

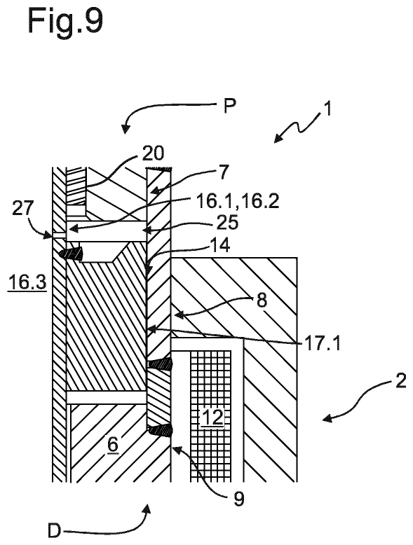

FIG. 9 shows a seventh embodiment, in which the distal guide bearing 21 has been omitted and the distal guide portion 9 has no actual guiding function. The armature shaft 16 is spaced apart from the distal guide portion 9 to allow for basically free gas exchange. Accordingly, there is no distal damper space 26 and the damping behavior is exclusively controlled by the proximal damper space 25, which is again connected to the shaft channel 16.3 via a gas-exchange path 27 that radially traverses the sleeve wall 16.2.

It will be appreciated that the embodiments shown in FIGS. 4, 5, 8 and 9 could be modified by employing a seal element 19 as in FIG. 7.

The passages 27 and 28 in the embodiments of FIGS. 4 to 9 may be designed as control (or calibrated orifice), since their cross-section will determine the leakage rate of the gas during compression.

### LEGEND OF REFERENCE NUMBERS

1 fuel injector
2 injector body
3 end portion
3.1 valve seat
4 fuel passage
5 outlet opening
6 pole piece
7,9 guide portion
8 cylinder portion
10 pintle
10.1 pintle shaft
10.2 pintle head
10.3 pintle perch
11 pintle spring
12 solenoid
14 annular gap
15 armature element
16 armature shaft
16.1 sleeve portion
16.2 sleeve wall
16.3 shaft channel
17 armature
17.1 outer surface
17.2, 17.3 recess
18 armature spring
19 seal element
20,21 guide bearing
25,26 damper space
27,28 gas-exchange path
A axial direction
D distal side
P proximal side

1. A fuel injector for direct injection of gaseous fuel, extending along an axial direction from a proximal side to a distal side and comprising:
an injector body defining a fuel passage and having a distally disposed end portion that defines a valve seat extending around an outlet opening;
an outward opening pintle received in the injector body to be axially movable between a proximal pintle position, in which it engages the valve seat to close the outlet opening, and a distal pintle position, in which it releases the outlet opening;
an armature element for engaging the pintle from the proximal side and being axially movable between a proximal armature position and a distal armature position, which corresponds to the distal pintle position; and
an actuator adapted to initiate a movement of the armature element towards the distal armature position,
wherein at least one damper space is defined between the armature element and the injector body so that a volume of the damper space is changed by an axial movement of the armature element, wherein a gap width of any gap in a boundary region delimiting the damper space is less than 15 μm, except for at least one gas-exchange path to which the damper space is connected, which gas-exchange path is open for gas exchange in any position of the armature element.

2. The fuel injector according to claim 1, wherein the armature element comprises an armature shaft, with a hollow sleeve portion disposed around a shaft channel that at least communicates with the fuel passage, and an armature that is circumferentially disposed around the armature shaft and fixedly connected thereto and that is disposed in a cylinder portion of the injector body, wherein at least one damper space is disposed axially between the armature and a guide portion of the injector body that protrudes radially inwards from the cylinder portion towards the armature shaft and that partially receives of the armature shaft.

3. The fuel injector according to claim 2, wherein the armature and the guide portion are formed so that they define a damper space with a non-zero volume between them when they engage each other.

4. The fuel injector according to claim 2, wherein a proximal damper space is disposed proximally of the armature and axially between a proximal guide portion of the injector body and the armature.

5. The fuel injector according to claim 2, wherein a distal damper space is disposed distally of the armature and axially between the armature and a distal guide portion of the injector body.

6. The fuel injector according to claim 1, comprising a proximal damper space and a distal damper space, which are connected by at least one gas-exchange path.

7. The fuel injector according to claim 2, wherein a gas-exchange path extends radially and traverses a sleeve wall of the sleeve portion to connect a damper space with the shaft channel.

8. The fuel injector according to claim 2, wherein a gas-exchange path extends axially and traverses the armature.

9. The fuel injector according to claim 2, wherein a gas-exchange path extends axially and is formed in a radially outer surface of the armature.

10. The fuel injector according to claim 2, wherein an at least mostly annular gap between the armature and the cylinder portion has a width of less than 15 μm.

11. The fuel injector according to claim 1, wherein the gas-exchange path has a cross-sectional area between 0.1 mm² and 0.6 mm².

12. The fuel injector according to claim 2, wherein a gas-exchange path is formed by an annular gap disposed radially between the armature and the cylinder portion.

13. The fuel injector according to claim 2, wherein at least one seal element is radially interposed between the armature and the cylinder portion wherein a seal-element gap between the seal element and the injector body has a maximum width of less than 15 μm.

14. The fuel injector according to claim 1, wherein the armature element and the pintle are separate elements or are fixedly connected.

15. The fuel injector according to claim 1, wherein the actuator includes a solenoid.

16. The fuel injector according to claim 12, wherein the annular gap has a width between 15 μm and 25 μm.
